(19) United States
(12) Patent Application Publication
(10) Pub. No.: US 2025/0227027 A1
(43) Pub. Date: Jul. 10, 2025

(54) Methods for Detecting, Evaluating, and Mitigating Conflicts in Open RAN Systems

(71) Applicant: Northeastern University, Boston, MA (US)

(72) Inventors: Leonardo BONATI, Boston, MA (US); Salvatore D'ORO, Brookline, MA (US); Tommaso MELODIA, Newton, MA (US); Pietro BRACH DEL PREVER, Somerville, MA (US); Michele POLESE, Cambridge, MA (US)

(21) Appl. No.: 19/013,377

(22) Filed: Jan. 8, 2025

Related U.S. Application Data
(60) Provisional application No. 63/622,034, filed on Jan. 17, 2024.
(60) Provisional application No. 63/618,893, filed on Jan. 8, 2024.

(51) Int. Cl. H04L 41/0873; H04L 41/5009

(52) U.S. Cl. CPC H04L 41/0873; H04L 41/5009

(57) ABSTRACT

Provided herein are methods and systems for detecting, evaluating, and mitigating conflicts in an open radio access network (open RAN) including a profiler for generating an application profile for each of a plurality of applications deployable on the open RAN by simulating a behavior of each application with respect to a corresponding parameter set under a predefined plurality of operational condition sets, a conflict detection component configured to determine a predicted existence of a conflict between a requested application and one or more currently instantiated applications, a conflict evaluation component configured to determine a predicted frequency and a predicted severity of the conflict, and a conflict mitigation component configured to develop a conflict mitigation scheme and, according to the conflict mitigation scheme, at least one of block instantiation of the requested application, instantiate the requested application, or uninstantiate at least one of the currently instantiated applications.

### CROSS REFERENCE TO RELATED APPLICATIONS

This application claims benefit under 35 U.S.C. § 119 (e) of U.S. Provisional Application No. 63/622,034, filed on 17 Jan. 2024, entitled “Methods for Detecting, Evaluating, and Mitigating Conflicts in Open RAN Systems” and of U.S. Provisional Application No. 63/618,893, filed on 8 Jan. 2024, entitled “Methods for Detecting, Evaluating, and Mitigating Conflicts in Open RAN Systems,” the entirety of each of which is incorporated by reference herein.

### STATEMENT REGARDING FEDERALLY SPONSORED RESEARCH OR DEVELOPMENT

This invention was made with government support under Grant No. W911NF-19-2-0221 awarded by the Army Research Office. The government has certain rights in the invention.

### BACKGROUND

The open Radio Access Network (open RAN) paradigm is spearheading the revolution in the telco ecosystem by promoting open, programmable, virtualized, multi-vendor, disaggregated cellular architectures. In this context, the O-RAN Alliance, a consortium that brings together vendors, operators, integrators and academic partners worldwide, has taken the lead in defining and specifying open RAN architectures, interfaces, operations and security requirements necessary to realize the open RAN vision. In particular, the O-RAN Alliance aims to define architectures, interfaces, operations, and security requirements for the open RAN, particularly emphasizing the introduction of RAN Intelligent Controllers (RICs). These, including Non-real-time (RT) RIC and Near-RT RIC, enable real-time control of cellular networks via Artificial Intelligence (AI)-driven applications, called rApps and xApps, paving the way to intelligent and self-organizing cellular networks. Specifically, O-RAN introduces the Non-RT RIC and the Near-RT RIC, both of which host intelligent applications that execute inference tasks (e.g., monitoring, control, forecasting), with the difference being that the former is designed to operate over timescales higher than 1 s via the so-called rApps, while the latter hosts xApps that perform inference over timescales ranging from 10 ms to 1 s. Open RANs that are compliant with the specifications propounded by the O-RAN Alliance are generally referred to as an “O-RAN”.

Although open RAN comes with an unprecedented level of innovation in the telco domain, one of its most disrupting technologies lies in the concept of the RAN Intelligent Controllers (RICs) and the introduction of intelligence in the network via the RICs. In particular, xApps and rApps introduce the possibility of dynamically and efficiently controlling RAN policies and reprogramming its behavior according to current demand and load. However, this revolution comes with unique challenges that are unprecedented in the telco ecosystem, particularly with respect to conflict management due to the plethora of AI solutions taking independent, and possibly contrasting, control decisions. Specifically, while legacy 4G and 5G architectures traditionally come with control policies baked in the hardware and with very few degrees of freedom, O-RAN opens such control policies to customization via Artificial Intelligence (AI) algorithms that process data collected in real time from the RAN to enable truly self-optimizing cellular networks. Put more simply, although it is clear that enabling real-time control of the RAN paves the way toward intelligent networks that can improve network efficiency and performance, and reduce energy consumption by tailoring resource allocation policies to demand and load, it also exposes the network to conflicts.

Conflicts in O-RAN are a serious concern, especially because it is still unclear how to guarantee that the fabric of AI-based, multi-vendor xApps and rApps makes decisions without generating conflicting control policies that might, for example, result in performance degradation, Service Level Agreement (SLA) violations, inefficiencies or, even worse, outages. A simple, yet illustrative, example is that of two xApps respectively trying to maximize downlink throughput and minimize energy consumption. Intuitively, while the former would produce resource allocation policies that maximize resource utilization to improve throughput, the latter would aim at minimizing resource utilization, reducing power, and potentially shutting down the base station to save energy.

Since conflicts can be different in nature, can be observable only at certain timescales and can affect different network components and Key Performance Measurements (KPMs), the O-RAN Alliance has classified them into three main categories: direct, indirect and implicit (we will discuss this classification in details throughout the paper). If on the one hand O-RAN promotes RICs and their intelligent decision making, on the other hand it is important that conflicts are handled properly in order to guarantee reliable and robust cellular networks.

For this reason, conflict management has received increasing interest from the community as an instrumental component to enable and promote O-RAN adoption. As described below, preliminary efforts in this domain include detecting conflicting control policies in real time [1, 2], coordinating AI-based xApps and rApps via team learning to reduce the occurrence of conflicts [8, 11], as well as orchestrating xApp and rApp selection and deployment to avoid conflicts [7].

For example, a systematic analysis of the challenges of the conflict control in the RAN and of the strategies proposed to address each challenge is presented in [1]. According to [1], preventive conflict mitigation activities should reliably detect conflicts, manage to continue also in an evolving network, provide the optimal resolution to conflict, and provide methodologies for testing and evaluate conflict mitigation methods.

An xApp-only, O-RAN-based conflict mitigation framework is presented in [2]. The framework resides in the Near-RT RIC and includes three units: a Conflict Detection (CD) Agent, a Conflict Resolution (CR) Agent, and a Performance Monitoring unit. The CD agent is divided into three components, each one addressing a different kind of conflict: the Direct Conflict Detection (DCD) component, the indirect Conflict Detection (ICD) component, and the Implicit Conflict Detection (ImCD) component. When a conflict is detected by CD Agent, the necessary information for mitigating the conflict are sent to the CR. The detection mechanism for all three components of the CD Agent is reactive with respect to the deployment of the xApp, i.e. the detection process happen when the xApps have already been deployed. The mechanism can be distinguished further based on the kind of conflict that is detected: the action of the first two components (DCD and ICD) happens when the xApps are already running, but before a control decision is effective; the action of the third component (ImCD) takes place instead when the control action is already effective. As [2] suggests, at least direct conflicts should be detected in the Service Management and Orchestration (SMO) before an xApp is deployed, but no solution is proposed for this. The CD Agent effectiveness is validated with simulated experiments in [2].

OrchestRAN is an Orchestration framework presented in [7] that orchestrates the deployment of intelligent, data-driven algorithms and computes the optimal location in the network to deploy them (e.g. at the edge, or in the cloud). OrchestRAN also addresses the problem of mitigating conflicts, by making sure that the selected ML/AI models do not generate conflicts, and that a control parameter or network functionality is controlled by a single model at a time. This means that OrchestRAN enacts preventive detection of direct conflicts only, but does not provide any detection mechanism, either preventive or reactive, for indirect or implicit conflicts. Furthermore, it does not provide any solution for mitigating the detected conflicts, e.g. by providing suggestions for alternative combinations of models to deploy to achieve the desired functionalities.

A team learning-based strategy to mitigate conflicts among xApps in the Near-RT RIC is defined in [11]. The team learning algorithm aims at reducing and possibly eliminating the conflicts among xApps. The strategy is based on as many instances of Deep Q-Network (DQN), a deep neural network-based, model-free algorithm that runs in the RIC, as the number of xApps that make use of it. DQN provides each xApp with rewards following every evaluation of the state of the system. Each xApp is required to share data about their planned control actions so that they can be evaluated by DQN. This increases a lot the communication among xApps (N²) and the consumption of processing and memory (N2), but also improves the overall network performance [11]. The results of this paper have been validated in simulated scenarios with different traffic and mobility models. As an expansion to this, a case study of multi-agent team learning in O-RAN is presented in [8]. Two xApps, one that controls power allocation and one that controls radio resource block allocation, and three control schemes, sequential multi-agent deep reinforcement learning (SMADRL), concurrent multi-agent deep reinforcement learning (CMADRL), and team multi-agent deep reinforcement learning (TMADRL), are considered. In SMADRL, the xApps act in sequence; in CMADRL the xApps act simultaneously; in TMADRL the xApps first exchange information about the planned action that each of them intends to take, and then they act. The authors show that the TMADRL scheme optimizes both energy utilization and throughput with respect to the two other schemes considered for multi-agent team learning.

However, despite these tangible efforts at designing and delivering solutions for handling and mitigating conflicts in O-RAN, no existing solution can account for the severity of potential conflicts or the likelihood that conflicts will arise under real-world operational conditions.

### SUMMARY

The present technology provides a set of systems and methods to detect, evaluate and mitigate conflicts between AI-based control applications in open RAN networks. This is a problem that has received coverage in the literature only on the deconfliction phase of the problem, which is not covered by the instant technology. At a high level, a 4-phase procedure has been developed that makes it possible to determine the existence and severity of conflicts between AI-based agents taking decisions that might be conflicting with each other (e.g., an application deciding to turn off a base station, and an application deciding to maximize transmission power for the same base station).

The present technology achieves this by the implementation of a framework tailored for characterizing, studying and evaluating conflicts in open RAN networks, including O-RAN networks. The system executes four major tasks, namely: application profiling, conflict detection, evaluation, and mitigation. In general, an Application Profiler generates application profiles that describe application behavior. A Conflict Detection Module uses such application profiles for detecting the occurrence of conflicts and identifying the affected parameters and KPMs. Upon detecting the existence of conflicts or potential conflicts, the Conflict Evaluation Module generates a report that summarizes severity of each conflict and how much the conflict impacts or could impacts the KPMs. A Conflict Mitigation Module leverages the information included in the report produced by the previous module to make informed decisions regarding the deployment of open RAN applications. It can use conflict management policies specified by the network operator to take decisions such as not deploying an application prone to generate too large of a conflict, or removing a subset of applications to reduce the severeness of conflicts below a certain desired threshold.

In one aspect, a method for detecting, evaluating, and mitigating conflicts in an open radio access network (open RAN) is provided. The method includes providing a plurality of applications deployable on the open RAN, each of the plurality of applications configured to control a corresponding parameter set including at least one operational parameter of the open RAN. The method also includes generating, in a profiler component, an application profile for each of the plurality of applications. Generating the application profile includes simulating a behavior of each application with respect to the corresponding parameter set under a predefined plurality of operational condition sets. Generating the application profile also includes compiling a statistical profile of each application for each of the predefined plurality of operational condition sets, the statistical profile characterizing configuration of the corresponding parameter set by the application under the corresponding operational condition set. The method also includes receiving, at a conflict detection component, a request to instantiate at least one of the applications on the open RAN. The method also includes obtaining current operational data from the open RAN, the method also includes determining, by the conflict detection component, a predicted existence of at least one conflict between the requested application and one or more currently instantiated applications. The method also includes determining, by a conflict evaluation component, a predicted frequency and a predicted severity of at least one conflict between the requested application and one or more currently instantiated applications, wherein the predicted severity represents a magnitude of predicted deviation from key performance measurements of the open RAN resulting from the at least one conflict. The method also includes generating, based on the determined predicted frequency and severity of the at least one conflict, a conflict report. The method also includes developing, by application of a conflict mitigation policy of the open RAN to the conflict report in a conflict mitigation component, a conflict mitigation scheme and, according to the conflict mitigation scheme, at least one of blocking instantiation of the requested application, instantiating the requested application, or uninstantiating at least one of the currently instantiated applications.

In some embodiments, one or more of the profiler component, the conflict detection component, the conflict evaluation component, the conflict mitigation component, or combinations thereof is executed at a Service Management and Orchestration of the open RAN. In some embodiments, the plurality of applications deployable on the open RAN include one or more rApps, xApps, dApps, or combinations thereof. In some embodiments, the at least one conflict includes one or more of a direct conflict, wherein the requested application is configured to control a same parameter as at least one of the currently instantiated applications, an indirect conflict, wherein the requested application is configured to control at least one parameter that directly affects a value of a parameter controlled by at least one of the currently instantiated applications, an implicit conflict, wherein the requested application is configured to control at least one parameter that affects a same key performance measurement as a parameter controlled by at least one of the currently instantiated applications, or combinations thereof. In some embodiments, conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.

In some embodiments, the conflict mitigation policy includes a conflict tolerance defining a tolerable deviation with respect to one or more of the key performance measurements, a tolerable deviation with respect to one or more operational parameters of the open RAN, or a combination thereof. In some embodiments, the method also includes receiving, from an operator, based on the conflict report, a change to the requested application, a request for deployment of a different application, a request for a change to the conflict mitigation policy, or combinations thereof. In some embodiments, the operational condition sets each include at least one of a number of user equipments, a cell load, a signal-to-noise-ratio, channel quality information conditions, or combinations thereof. In some embodiments, the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof. In some embodiments, the statistical profile includes at least one of a Probability Distribution Function, a Cumulative Distribution Function, an Empirical Cumulative Distribution Function, or combinations thereof.

In another aspect, a system for detecting, evaluating, and mitigating conflicts in an open radio access network (open RAN) is provided. The system includes a profiler component. The profiler component is configured to receive a plurality of applications deployable on the open RAN, each configured to control a corresponding parameter set including at least one operational parameter of the open RAN. The profiler component is also configured to generate an application profile for each of the plurality of applications by simulating a behavior of each application with respect to the corresponding parameter set under a predefined plurality of operational condition sets, compiling a statistical profile of each application for each of the predefined plurality of operational condition sets, the statistical profile characterizing configuration of the corresponding parameter set by the application under the corresponding operational condition set. The system also includes a conflict detection component. The conflict detection component is configured to receive a request to instantiate one of the applications on the open RAN. The conflict detection component is also configured to obtain current operational data from the open RAN. The conflict detection component is also configured to determine a predicted existence of at least one conflict between the requested application and one or more currently instantiated applications. The system also includes a conflict evaluation component. The conflict evaluation component is configured to determine a predicted frequency and a predicted severity of the at least one conflict between the requested application and one or more currently instantiated applications, wherein the predicted severity represents a magnitude of predicted deviation from key performance measurements of the open RAN resulting from the at least one conflict. The conflict evaluation component is also configured to generate, based on the determined predicted frequency and severity of the at least one conflict, a conflict report. The system also includes a conflict mitigation component configured to develop, by application of a conflict mitigation policy of the open RAN to the conflict report, a conflict mitigation scheme and, according to the conflict mitigation scheme, at least one of block instantiation of the requested application, instantiate the requested application, or uininstantiate at least one of the currently instantiated applications.

In some embodiments, one or more of the profiler component, the conflict detection component, the conflict evaluation component, the conflict mitigation component, or combinations thereof is executed at a Service Management and Orchestration of the open RAN. In some embodiments, the plurality of applications deployable on the open RAN include one or more rApps, xApps, dApps, or combinations thereof. In some embodiments, the at least one conflict includes one or more of a direct conflict, wherein the requested application is configured to control a same parameter as at least one of the currently instantiated applications, an indirect conflict, wherein the requested application is configured to control at least one parameter that directly affects a value of a parameter controlled by at least one of the currently instantiated applications, an implicit conflict, wherein the requested application is configured to control at least one parameter that affects a same key performance measurement as a parameter controlled by at least one of the currently instantiated applications, or combinations thereof. In some embodiments, conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.

In some embodiments, the conflict mitigation policy includes a conflict tolerance defining a tolerable deviation with respect to one or more of the key performance measurements, a tolerable deviation with respect to one or more operational parameters of the open RAN, or a combination thereof. In some embodiments, the conflict mitigation component is configured to receive, from an operator, based on the conflict report, instructions requesting a change to the requested application, requesting deployment of a different application, requesting a change to the conflict mitigation policy, or combinations thereof. In some embodiments, the operational condition sets each include at least one of a number of user equipments, a cell load, a signal-to-noise-ratio, channel quality information conditions, or combinations thereof. In some embodiments, the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof. In some embodiments, the statistical profile includes at least one of a Probability Distribution Function, a Cumulative Distribution Function, an Empirical Cumulative Distribution Function, or combinations thereof.

Additional features and aspects of the technology include the following:
1. A method for detecting, evaluating, and mitigating conflicts in an open radio access network (open RAN) comprising:
   providing a plurality of applications deployable on the open RAN, each of the plurality of applications configured to control a corresponding parameter set including at least one operational parameter of the open RAN;
   generating, in a profiler component, an application profile for each of the plurality of applications by:
      simulating a behavior of each application with respect to the corresponding parameter set under a predefined plurality of operational condition sets, and
      compiling a statistical profile of each application for each of the predefined plurality of operational condition sets, the statistical profile characterizing configuration of the corresponding parameter set by the application under the corresponding operational condition set;
   receiving, at a conflict detection component, a request to instantiate at least one of the applications on the open RAN,
   obtaining current operational data from the open RAN;
   determining, by the conflict detection component, a predicted existence of at least one conflict between the requested application and one or more currently instantiated applications;
   determining, by a conflict evaluation component, a predicted frequency and a predicted severity of at least one conflict between the requested application and one or more currently instantiated applications, wherein the predicted severity represents a magnitude of predicted deviation from key performance measurements of the open RAN resulting from the at least one conflict;
   generating, based on the determined predicted frequency and severity of the at least one conflict, a conflict report;
   developing, by application of a conflict mitigation policy of the open RAN to the conflict report in a conflict mitigation component, a conflict mitigation scheme and, according to the conflict mitigation scheme, at least one of:
      blocking instantiation of the requested application;
      instantiating the requested application; or
      uninstantiating at least one of the currently instantiated applications.
2. The method of feature 1, wherein one or more of the profiler component, the conflict detection component, the conflict evaluation component, the conflict mitigation component, or combinations thereof is executed at a Service Management and Orchestration of the open RAN.
3. The method of any of features 1-2, wherein the plurality of applications deployable on the open RAN include one or more rApps, xApps, dApps, or combinations thereof.
4. The method of any of features 1-3, wherein the at least one conflict includes one or more of:
   a direct conflict, wherein the requested application is configured to control a same parameter as at least one of the currently instantiated applications;
   an indirect conflict, wherein the requested application is configured to control at least one parameter that directly affects a value of a parameter controlled by at least one of the currently instantiated applications;
   an implicit conflict, wherein the requested application is configured to control at least one parameter that affects a same key performance measurement as a parameter controlled by at least one of the currently instantiated applications; or
   combinations thereof.
5. The method of any of features 1-4, wherein conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.
6. The method of any of features 1-5, wherein the conflict mitigation policy includes a conflict tolerance defining:
   a tolerable deviation with respect to one or more of the key performance measurements;
   a tolerable deviation with respect to one or more operational parameters of the open RAN; or
   a combination thereof.
7. The method of any of features 1-6, further comprising receiving, from an operator, based on the conflict report, a change to the requested application, a request for deployment of a different application, a request for a change to the conflict mitigation policy, or combinations thereof.
8. The method of any of features 1-7, wherein the operational condition sets each include at least one of a number of user equipments, a cell load, a signal-to-noise-ratio, channel quality information conditions, or combinations thereof.
9. The method of any of features 1-8, wherein the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof.
10. The method of any of features 1-9, wherein the statistical profile includes at least one of a Probability Distribution Function, a Cumulative Distribution Function, an Empirical Cumulative Distribution Function, or combinations thereof.
11. A system for detecting, evaluating, and mitigating conflicts in an open radio access network (open RAN) comprising:
   a profiler component configured to:
      receive a plurality of applications deployable on the open RAN, each configured to control a corresponding parameter set including at least one operational parameter of the open RAN, and
      generate an application profile for each of the plurality of applications by simulating a behavior of each application with respect to the corresponding parameter set under a predefined plurality of operational condition sets, compiling a statistical profile of each application for each of the predefined plurality of operational condition sets, the statistical profile characterizing configuration of the corresponding parameter set by the application under the corresponding operational condition set;
   a conflict detection component configured to:
      receive a request to instantiate one of the applications on the open RAN,
      obtain current operational data from the open RAN, and
      determine a predicted existence of at least one conflict between the requested application and one or more currently instantiated applications;
   a conflict evaluation component configured to:
      determine a predicted frequency and a predicted severity of the at least one conflict between the requested application and one or more currently instantiated applications, wherein the predicted severity represents a magnitude of predicted deviation from key performance measurements of the open RAN resulting from the at least one conflict, and
      generate, based on the determined predicted frequency and severity of the at least one conflict, a conflict report;
   a conflict mitigation component configured to develop, by application of a conflict mitigation policy of the open RAN to the conflict report, a conflict mitigation scheme and, according to the conflict mitigation scheme, at least one of:
      block instantiation of the requested application;
      instantiate the requested application; or
      uninstantiate at least one of the currently instantiated applications.
12. The system of feature 11, wherein one or more of the profiler component, the conflict detection component, the conflict evaluation component, the conflict mitigation component, or combinations thereof is executed at a Service Management and Orchestration of the open RAN.
13. The system of any of features 11-12, wherein the plurality of applications deployable on the open RAN include one or more rApps, xApps, dApps, or combinations thereof.
14. The system of any of features 11-13, wherein the at least one conflict includes one or more of:
   a direct conflict, wherein the requested application is configured to control a same parameter as at least one of the currently instantiated applications;
   an indirect conflict, wherein the requested application is configured to control at least one parameter that directly affects a value of a parameter controlled by at least one of the currently instantiated applications;
   an implicit conflict, wherein the requested application is configured to control at least one parameter that affects a same key performance measurement as a parameter controlled by at least one of the currently instantiated applications; or
   combinations thereof.
15. The system of any of features 11-14, wherein conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.
16. The system of any of features 11-15, wherein the conflict mitigation policy includes a conflict tolerance defining:
   a tolerable deviation with respect to one or more of the key performance measurements;
   a tolerable deviation with respect to one or more operational parameters of the open RAN; or
   a combination thereof.
17. The system of any of features 11-16, the conflict mitigation component further configured to receive, from an operator, based on the conflict report, instructions requesting a change to the requested application, requesting deployment of a different application, requesting a change to the conflict mitigation policy, or combinations thereof.
18. The system of any of features 11-17, wherein the operational condition sets each include at least one of a number of user equipments, a cell load, a signal-to-noise-ratio, channel quality information conditions, or combinations thereof.
19. The system of any of features 11-18, wherein the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof.
20. The system of any of features 11-19, the statistical profile includes at least one of a Probability Distribution Function, a Cumulative Distribution Function, an Empirical Cumulative Distribution Function, or combinations thereof.

### BRIEF DESCRIPTION OF THE DRAWINGS

FIG. 1 is a KPM Graph (G^{K}) wherein parameters p₁, p₂ both impact KPM k₂, and conflict arises.

FIG. 2 is a Parameter Graph (G^{P}) wherein parameters p₁, p₂, p₃ each impact themselves and p₁ also impacts p₂, creating conflict.

FIG. 3 is a functional flow diagram illustrating a system for detecting, evaluating, and mitigating conflicts in an open RAN.

FIG. 4 is a functional flow diagram illustrating profiling of new O-RAN applications and generation of statistical profiles therefor in a system for detecting, evaluating, and mitigating conflicts in an open RAN.

FIG. 5 is an augmented G^{P} to detect direct conflicts (e.g., at p₂) and indirect conflicts (e.g., at p₃).

FIG. 6 is an augmented G^{K} to detect direct conflicts (e.g., at p₂) and implicit conflicts (e.g., at k₁).

FIG. 7 is a plot illustrating CDF vs Data Values for two potentially conflicting applications as well as various methods of assessing a severity of such conflicts.

FIG. 8 is a functional flow diagram illustrating a conflict evaluation module in a system for detecting, evaluating, and mitigating conflicts in an open RAN.

### DETAILED DESCRIPTION

Provided herein are methods and systems for detecting, evaluating, and mitigating conflicts in an open radio access network (open RAN). An objective of such methods and systems is to detect, evaluate and mitigate conflicts between AI-based control applications in open RAN. In this respect, novel features of the present technology include the first programmatic framework for detecting, evaluating and mitigating conflicts in open RAN, a testing procedure for generating data necessary to profile conflicts in open RAN, a data-driven methodology where conflicts are detected by looking at statistical behavior of open RAN applications, and a general, end-to-end approach for detecting, evaluating and mitigating conflicts in open RAN.

At a high level, a 4-phase procedure has been developed that makes it possible to determine the existence and severity of conflicts between AI-based agents taking decisions that might be conflicting with each other (e.g., an application deciding to turn off a base station, and an application deciding to maximize transmission power for the same base station).

The present technology achieves this by the implementation of a framework tailored for characterizing, studying and evaluating conflicts in open RAN networks, including O-RAN networks. The system executes four major tasks, namely: application profiling, conflict detection, evaluation, and mitigation. In general, an Application Profiler generates application profiles that describe application behavior. A Conflict Detection Module uses such application profiles for detecting the occurrence of conflicts and identifying the affected parameters and KPMs. Upon detecting the existence of conflicts or potential conflicts, the Conflict Evaluation Module generates a report that summarizes severity of each conflict and how much the conflict impacts or could impacts the KPMs. A Conflict Mitigation Module leverages the information included in the report produced by the previous module to make informed decisions regarding the deployment of open RAN applications. It can use conflict management policies specified by the network operator to take decisions such as not deploying an application prone to generate too large of a conflict, or removing a subset of applications to reduce the severeness of conflicts below a certain desired threshold.

Although shown and described herein with specific reference to O-RAN networks and network components, the systems and methods described herein can also be used in connection with any other suitable network including, for example, other open RAN networks, any wireless network where independent applications can compete with each other to control the network (e.g., where independent applications might generate conflicts), legacy 4G/5G networks where intelligence runs in SMO, EMS and other cloud hosts, AI-based wireless networks with distributed control via multiple control applications, and combinations thereof.

In some embodiments, these systems and methods provide an empirical framework, hereinafter also referred to as “PACIFISTA” that leverages a hierarchical graph and statistical information regarding O-RAN applications to determine the likelihood and severity of conflicts prior to deploying O-RAN applications. In addition, a profiling pipeline is provided to test O-RAN applications through sandbox tests and a mathematical model based on statistical data is provided to infer conflict existence and severity. Furthermore, experiments run on an O-RAN-compliant testbed are described which demonstrate PACIFISTA's ability to predict conflicts and provide valuable information for informed deployment decisions.

More specifically, the methods and systems provided herein include PACIFISTA, an empirical framework that leverages statistical information on O-RAN applications (e.g., xApps, rApps and even dApps, as proposed in [6]) behavior to detect, characterize and mitigate conflicts that might arise between different applications. PACIFISTA combines the use of a hierarchical graph with statistical behavior of O-RAN applications to capture relationships between control parameters and KPMs and: (i) determine if two or more applications will generate conflicts; and (ii) quantify the severity of such conflicts.

Also provided herein is a profiling pipeline to test O-RAN applications across a set of predefined sandbox tests. Also described herein is a derived mathematical model that uses statistical data generated during the profiling phase to infer conflict existence and severity. Several statistical measures and tools that can be used to assess the severity of each conflict and identify affected KPMs and control parameters are also described herein.

Further described herein are experiments, run on an O-RAN-compliant testbed with real xApps, which demonstrate the capabilities of PACIFISTA. It is shown that PACIFISTA can predict the occurrence of conflicts and can provide accurate information regarding which KPMs will be affected the most and to what extent. In this way, PACIFISTA offers a-priori knowledge that can be used to evaluate conflicts prior to the deployment of O-RAN applications so as to facilitate informed deployment decisions on which xApps/rApps to deploy to mitigate conflicts.

### Modeling Conflicts in O-RAN

Described herein is PACIFISTA's conflict model and notation that will be useful throughout to characterize conflicts in great detail and connect them to the concept of conflict as specified by the O-RAN Alliance.

Let A be the set representing the catalog of O-RAN applications that can be deployed on the RICs. For the sake of generality, in this work, consider rApps, xApps and dApps [6], applications that extend O-RAN intelligence to the Central Units (CUs) and Distributed Units (DUs). Let P be the set of parameters that can be controlled by applications in A, and K be the set of observable KPMs. Specifically, for each application α∈A and parameter p∈P, define an indicator α_{α,p}∈{0, 1} such that α_{α, p}=1 if application α controls parameter p, and α_{α,p}=0 otherwise. The set P^{α}={p∈P: α_{α,p}=1}⊆ P can then be defined to identify the subset of parameters that are controlled by a. Accordingly, the following two graphs are built:

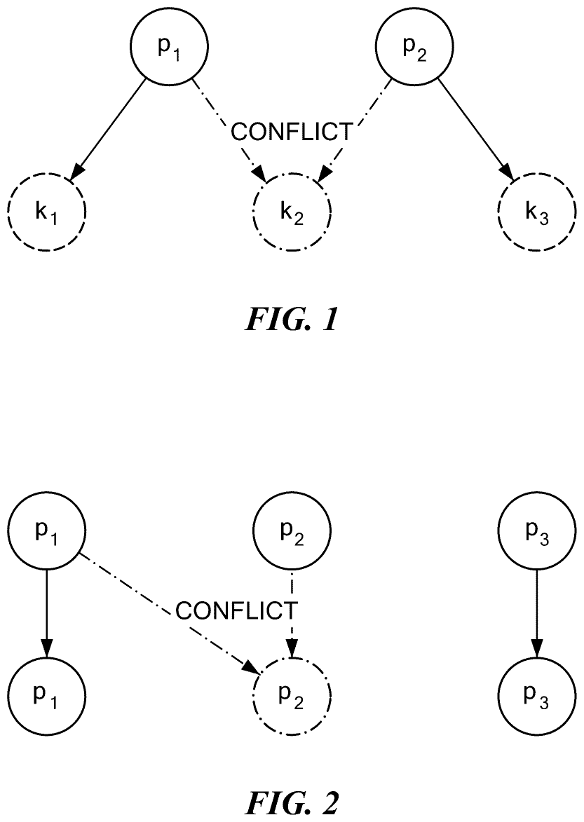

KPM Graph (G^{K}): this graph G^{K}=(V^{K}, E^{K}) is illustrated in FIG. 1 and is used to represent relationships between control parameters and KPMs. Nodes of G^{K} are both control parameters and KPMs, i.e., V^{K}=PUK, and edges E^{K} are used to represent whether or not a control parameter p∈P impacts a certain KPM k∈K. Specifically, any 2-tuple (p, k)∈P×K is an edge of G^{K}, i.e., (p, k)∈P×K if and only if parameter p directly affects KPM k. Let ε_{p,k}∈{0, 1} be an indicator variable such that ∈_{p,k}=1 if p impacts KPM k, and ε_{p,k}=0 otherwise. It can be formally defined that E^{K}={(p, m)∈P×K: ε_{p,k}=1}. In FIG. 1, an example is shown with two parameters (i.e., P={p₁, p₂}) and three KPMs (i.e., K={k₁, k₂, k₃}) where p₁ impacts k₁ and k₂, while p₂ impacts k₂ and k₃.

Parameter Graph (G^{P}): this graph is illustrated in FIG. 2 and is used to represent relationships among control parameters. Specifically, nodes of G^{P} are V^{P}=P and edges E^{P} are used to represent dependencies between parameters. For any 2-tuple (p₁, p₂)∈P×P, let πp₁,p₂ ∈{0, 1} be an indicator parameter such that πp₁,p₂=1 if parameter p₁ impacts parameter p₂, πp₁,p₂=0 otherwise. This graph aims at capturing dependencies between parameters, especially in those cases where the value of a parameter p₁ affects directly the value that p₂ can take. For example, if p₁ is used to switch off a base station, and p₂ represents its transmission power, it is clear that p₂=0 if the base station is switched off (i.e., p₁=0). Formally, E^{P}={(p₁, p₂)∈P×P: πp₁,p₂=1}.

With the above notation, the three classes of conflicts identified by the O-RAN Alliance are introduced and then converted into a formal definition below.

Direct conflicts are conflicts that arise when two or more xApps/rApps control the same parameter. For example, this occurs when two xApps both control network slicing policies (potentially with conflicting objectives).

Indirect conflicts occur when different xApps/rApps control a set of parameters that directly affect the value of another set of parameters. As mentioned above, an example is that of an rApp shutting down a base station and an xApp trying to adjust its transmission power.

Implicit conflicts arise when two or more xApps/rApps control different parameters but affect the same KPM. A well-known example of conflict that belongs to this class is that of an energy saving rApps that jointly reduces bandwidth, transmission power and coverage range to improve energy-efficiency, while an xApp requests high resource utilization to support video streaming applications. Intuitively, both applications will impact the throughput experienced by served users. The rApp will negatively impact throughput due to the reduction in achievable capacity of the cell, while the second will try to use as many spectrum resources as possible to deliver the highest throughput.

Formally, these conflicts can be defined as follows:

Definition 1 (Direct Conflict). Let p∈P be any parameter. Let α₁ and α₂ be any two applications in A. Then α₁ and α₂ are in direct conflict with respect to parameter p if p∈P_{α}_{₁}_{,α}_{₂}^{DC}=P_{α}_{₁}∩P_{α}_{₂}.

Definition 2 (Indirect Conflict). Let α₁ and α₂ be any two applications in A. Then parameter p₁∈P_{α}_{₁} controlled by application α₁ indirectly conflicts with parameter p₁εP_{α}_{₁} controlled by α₂ if (p₁, p₂)∈E^{P}, i.e., πₚ_{₁}_{,p}_{₂}=1.

Definition 3 (Implicit Conflict). Let α₁ and α₂ be any two applications in A. Then @1 and α₂ generate an implicit conflict with respect to KPM k∈K if there exists at least one 2-tuple (p₁, p₂)∈P_{α}_{₁}×P_{α}_{₂}, with p₁≠p₂ such that ∈ₚ_{₁}_{,k}=∈ₚ_{₂}_{,k}=1.

### PACIFISTA Overview

Described herein is an exemplary architecture of PACIFISTA, including its building blocks, main functionalities, and procedures as well as how it can be integrated with the O-RAN architecture to execute conflict management procedures.

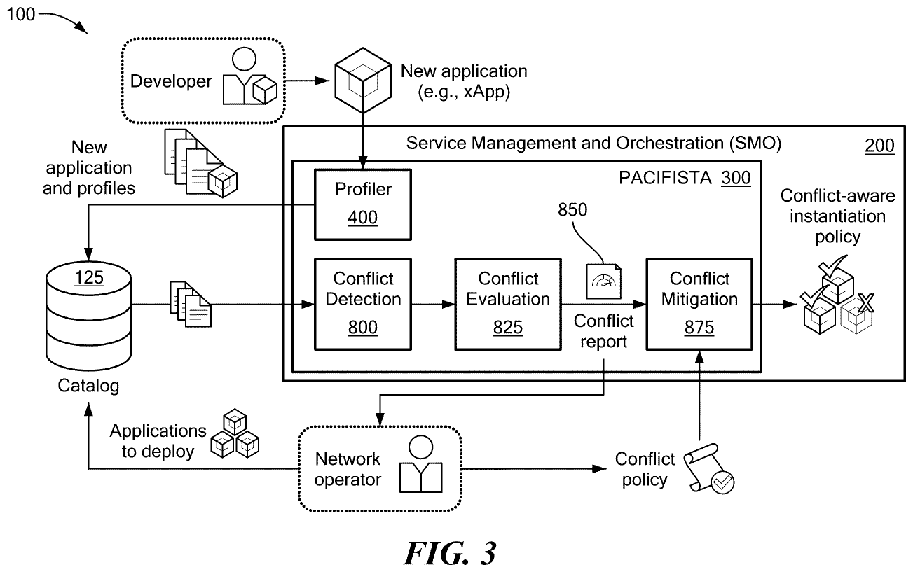

PACIFISTA has a modular architecture (FIG. 3) that consists of four major logical blocks and a catalog of applications (e.g., rApps, xApps and dApps) that can be deployed as described below.

In some embodiments, PACIFISTA executes four major tasks, namely application profiling, conflict detection, evaluation, and mitigation. Referring now to FIGS. 3, 4, and 8, PACIFISTA 300 is installed in a Service Management and Orchestration (SMO) 200 of an open RAN network 100. PACIFISTA 300 includes a Profiler 400 for generating application profiles 425 corresponding to each application for describing the corresponding application's behavior. A Conflict Detection Module 800 uses such profiles 425 for detecting the occurrence of conflicts and identifying affected parameters and KPMs. Upon detecting the existence of conflicts, a Conflict Evaluation Module 825 generates a Conflict Report 850 summarizing severity of the conflict and how much it impacts the KPMs. Finally, a Conflict Mitigation Module 875 leverages the information included in the Conflict Report 850 produced by the Conflict Evaluation Module 825 to make informed decisions with respect to the deployment of O-RAN applications. The Conflict Mitigation Module 875 uses conflict management policies specified by a network operator to take decisions such as whether to refuse to deploy an application at risk of creating a conflict exceeding a severity and/or likeliness threshold, or removing a subset of applications from an application catalog 125 to reduce the severeness of conflicts below a desired threshold.

### O-RAN Applications Catalog

The Catalog 125 hosts rApps, xApps, and dApps that can be deployed on an O-RAN network. For each application, the catalog 125 stores an application profile 425. For any application α∈A, the corresponding application profile 425 includes an identifier used to uniquely identify each application, a parameter set specifying a list of parameters directly controlled by the application (P_{α}), and statistical profiles, which provide statistical information regarding behavior of the application when executing under a set of operational conditions 401. It is assumed that applications are benchmarked on a set C of pre-defined operational conditions or use cases 401. Each operational condition c∈C might specify, among others, the number of User Equipments (UEs), cell load, Signal-to-Noise-Ratio (SNR)/Channel Quality Information (CQI) conditions. For each c, the statistical profile of the application is stored and includes Probability Distribution Functions (PDFs), Cumulative Distribution Functions (CDFs), Empirical Cumulative Distribution Functions (ECDFs), or combinations thereof. These are used to characterize how the application a configures the parameters in P_{α} when operating under conditions c. In some embodiments ECDFs can be used because they are advantageously easy to compute and can be extracted directly from data.

An example of such a statistical profile is shown in Listing 1 where the descriptor of an xApp with identifier xApp001 is shown controlling power control and slicing policies under condition low-load. The profile also includes CDFs that describe the statistical behavior for both control parameters (i.e., param) and KPMs (kpm). In order to properly capture conflicts in O-RAN, it is important to notice that conflicts are strongly dependent on operational conditions. More specifically, it is generally incorrect to state that two applications will always conflict with each other. Indeed, two applications α₁ and α₂ might heavily conflict with each other under operational conditions c₁, but might not generate any conflict under conditions c₂. For this reason, it is important to capture the statistical behavior of each application across C and evaluate conflicts for each operational condition of interest.

Listing 1: An example of an application profile of an
xApp controlling slicing and power control strategies.

| | |
|---|---|
| 1 | id: xApp001 |
| 2 | params: [“slicing”, “tx_power”] |
| 3 | conditions: “low-load” |
| 4 | profile: |
| 5 | cdfs: |
| 6 | cdf1: |
| 7 | name: “slicing” |
| 8 | type: “param” |
| 9 | xval: [0, 10, ..., 30, 50] |
| 10 | yval: [0.01, 0.05, ..., 0.9, 1] |
| 11 | cdf2: |
| 12 | name: “tx_power” |
| 13 | type: “param” |
| 14 | xval: [0, 20, ..., 80, 100] |
| 15 | yval: [0.0, 0.1, ..., 0.99, 1] |
| 16 | cdf3: |
| 17 | name: “tx_pckts_uplink” |
| 18 | type: “kpm” |
| 19 | xval: [0, 250, ..., 750, 1000] |
| 20 | yval: [0.1, 0.12, ..., 0.97, 1] |

Creating statistical profiles. The creation of the statistical profiles is one of the most important aspects of PACIFISTA. As shown below, these profiles are used by PACIFISTA to detect, evaluate and mitigate conflicts and therefore play a relevant role in managing conflicts.

In PACIFISTA, the statistical profiles are created by executing sandbox testing operations 403 under each condition specified in C. This was achieved in the experimental prototype by leveraging the Colosseum network emulator [4] and the OpenRAN Gym open-source O-RAN framework [5].

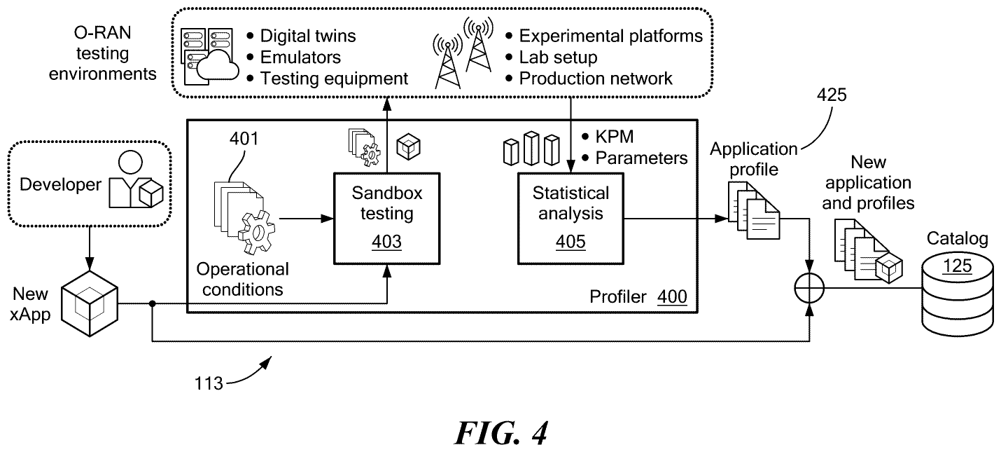

This procedure as shown in FIG. 4, includes first identifying and generating of benchmark operational conditions 401. This step includes creating testing scenarios to be included in C and used as benchmarks to evaluate conflicts. These are generated according to availability of an O-RAN testing environment. Digital twins (e.g., Colosseum [4]), network emulators (e.g., ns-3 [9]), and testing equipment (e.g., RIC, RAN testers) are ideal platforms as these are controllable and reproducible environments. However, this does not exclude the use of over-the-air experimental platforms, lab setups, and/or portions of production networks. Experimentally, Colosseum was used to generate cellular scenarios by specifying topology (extracted from GPS coordinates from OpenCelliD [10]), RF conditions (e.g., multi-path, fading), mobility, and traffic profiles, among others.

In addition to creating new scenarios, those scenarios already available on the Colosseum platform [3] were also leveraged. Details regarding these scenarios will are described below. Note that an application α∈A can only control P_{α}, and those not controlled by a, i.e.,

$${P}_{- a} = \frac{P}{{P}_{a}} ,$$

can assume multiple values. For this reason, it is assumed that each testing scenario c also specifies the values of parameters in P_{-α}. In this way, the same application α can be benchmarked across multiple testing scenarios that have the same topology, RF conditions, mobility, and traffic profiles, but have different parameter configurations.

The procedure of FIG. 4 also includes benchmark testing and data collection. In this step, an application α∈A is selected and a sandbox test 403 is executed under the considered testing scenario c E C. Data collection is performed via O-RAN interfaces (e.g., O1, E2, A1) and includes both KPMs K and control parameters P. In this context, both parameters controlled by a and those that are not are stored. Note that parameters in P_{-α} can be either fixed (e.g., assuming their default value), or change dynamically due to deterministic policies or due to other applications controlling them. In this latter case, where there is a need to test multiple applications executing at the same time (e.g., an xApp α₁ and an rApp α₂), such applications are treated as a “virtual” application a that controls P_{α}=P_{α}_{₁}UP_{α}_{₂}.

The procedure of FIG. 4 also includes processing, by statistical analysis 405, the data generated in the previous step to produce the statistical profile of the application profile 425, which describes the control behavior of application α under testing scenario c, and the subsequent impact on KPMs. Although no assumptions were made regarding how much information is included in the statistical profile, it is reasonable to assume that it might, in some implementations, be impractical to store all the raw data for each benchmark due to its sheer size. As a reference point, a single benchmark created using the prototype generates 1.66 Mbps/gNB of data when serving 6 UEs and storing more than 30 KPMs for each one of them. For this reason, the conflict evaluation pipeline is designed to only require statistical information regarding such data. Specifically, PACIFISTA uses CDFs of KPMs as described herein.

The procedure of FIG. 4 also includes generation of application profiles 425 and storage thereof. Once the statistical profiles are generated as described above, they are attached to the application α to produce the application profile 425, which can then be published in the application catalog 125.

As prototyped, profiles were generated using YAML files, but any other suitable approaches can be used in accordance with various embodiments.

Integration with O-RAN

As shown in FIG. 3, PACIFISTA runs as a component of the SMO and interfaces with the RICs and RAN nodes through the interfaces defined by O-RAN. Specifically, PACIFISTA leverages the internal messaging infrastructure of the SMO to access the O1 termination, which is then used to communicate with the RICs and RAN nodes (e.g., CUs and DUs). The O1 and R1 interfaces also allow PACIFISTA to profile xApps running on the Near-RT RIC and rApps on the Non-RT RIC, respectively. This happens by evaluating applications in one or more of the sandboxed environments in FIG. 3. This process unfolds in two steps. First, PACIFISTA gathers raw data and statistics on the decisions xApps and rApps take, based on the live KPMs obtained from the RAN nodes through the E2 interface (in the case of xApps) and O1 interface (in the case of rApps). The same RAN KPMs are also gathered by PACIFISTA via the O1 interface. After the data collection phase is completed, PACIFISTA performs its profiling operations through statistical analysis on the collected data. Specifically, as described herein, PACIFISTA extracts ECDFs for both parameters and KPMs and generates the application profile to be included in the application catalog.

As described below, the operator can specify conflict management policies that are used to determine which xApps and rApps can be deployed on the RICs depending on the level of conflict they generate. Once PACIFISTA makes a decision on the subset of ORAN applications to deploy, the O1 interface is used to deploy xApps on the Near-RT RIC, while the internal messaging infrastructure of the SMO is used to deploy rApps on the Non-RT RIC. In both cases, xApps and rApps are instantiated from a catalog hosted in the SMO. Similarly, existing applications can be undeployed by PACIFISTA in case they would conflict with new applications that need to be instantiated. The O-RAN interfaces also enable PACIFISTA to manage and monitor applications that have already been deployed. As an example, the O1 (in the case of xApps) and the R1 interface (in the case of rApps) can be used to perform health checks on the status of the running applications, or to tune their configuration.

### Detecting Conflicts

The first step in conflict mitigation lies in detecting the occurrence of any conflicts. Specifically, the Conflict Detection Module 800 takes as input the set of applications A*⊆A that the operator is willing to deploy and (i) provides a comprehensive list of applications that will generate conflicts; and (ii) identifies the set of parameters that will be impacted. In practical applications, this set can be represented as A*=A^{new}UA^{old}, where A^{new} and A^{old} are the set of new applications that need to be deployed and the set of applications that are already deployed, respectively.

### Detecting Direct Conflicts

Following from Definition 1, the set PDC of parameters that suffer from direct conflicts with respect to the application set A* is defined as follows:

$${Π}^{DC} ( {A}^{*} ) = \{ p ∈ {⋃}_{a ∈ {A}^{*}} {P}_{a} : {\sum }_{a ∈ {A}^{*}} {α}_{a , p} > 1 \} \qquad Eq . ( 1 )$$

To identify these parameters, the Parameter Graph G^{P} is augmented by adding an extra layer above that represents the applications in A*. Specifically, as many nodes are added as there are applications in A* and any edge (α, p)∈A*×P is generated such that α_{α,p}=1.

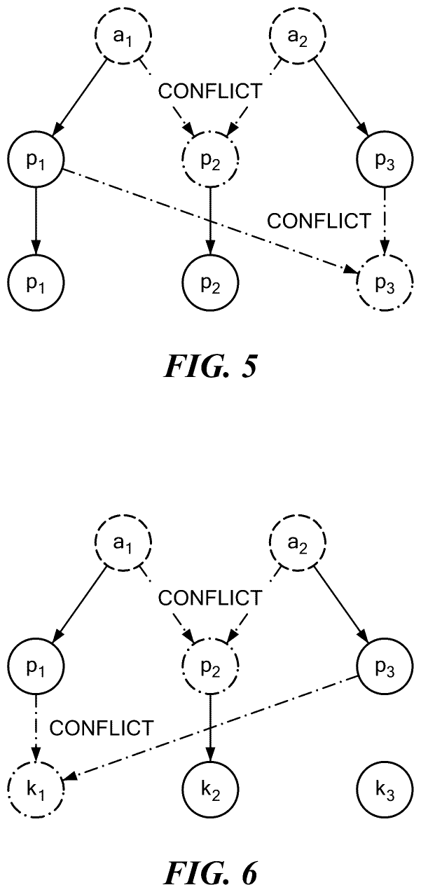

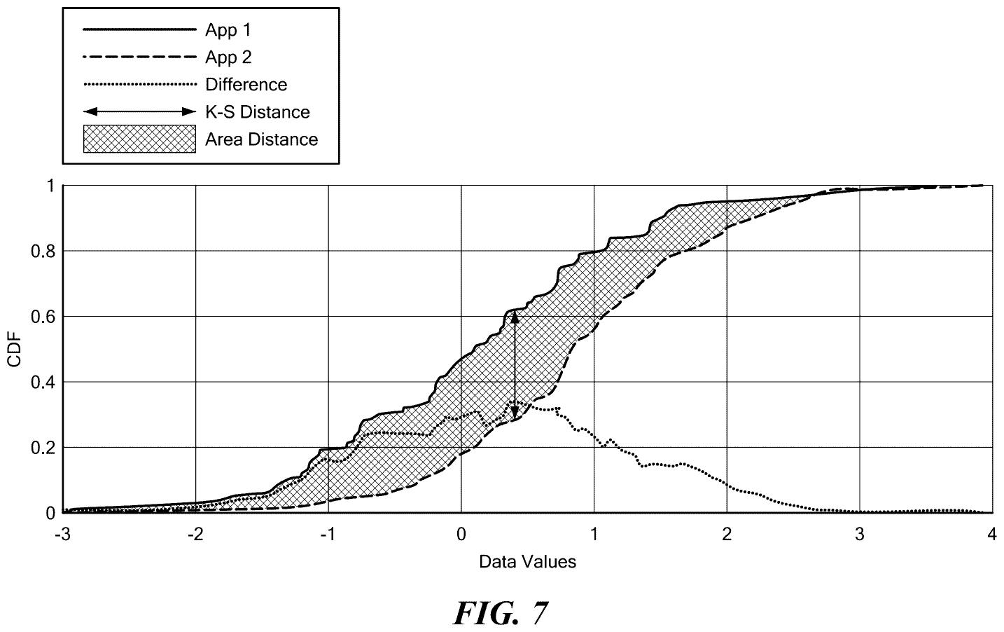

An example of this graph, which PACIFISTA also uses to identify indirect conflicts with two applications and a total of three controllable parameters is shown in FIG. 5. Application α₁ controls p₁ and p₂, while α₂ controls p₂ and p₃. FIG. 5 shows how the two applications generate a direct conflict with respect to p₂ as this parameter has more than one incoming edges.

For each parameter p∈Π^{DC}(A*), the subset of applications in A* that generate a direct conflict on p are identified as follows:

$${Θ}_{p}^{DC} ( {A}^{*} ) = \{ a ∈ {A}^{*} : {α}_{a , p} = 1 \} \qquad Eq . ( 2 )$$

For example, from FIG. 5 it is determined that Π^{DC}(A*)={p₂} and Θₚ_{₂}^{DC}(A*)={α₁, α₂}.

### Detecting Indirect Conflicts

From Definition 2 and by using the augmented graph described above and illustrated in FIG. 5, indirect conflicts can be characterized by identifying the following two sets:

$${Π}^{IDC} ( {A}^{*} ) = \{ p ∈ {⋃}_{a ∈ {A}^{*}} {P}_{a} : {\sum }_{p ′ {⋃}_{a ∈ {A}^{*}} {P}_{a}} {π}_{p ′ , p} > 1 \} \qquad Eq . ( 3 )$$

$$and$$

$${Θ}_{p}^{IDC} ( {A}^{*} ) = \{ a ∈ {A}^{*} : {α}_{a , p} = 1 \} \qquad Eq . ( 4 )$$

for each parameter p∈Π^{IDC}(A*).

From FIG. 5 (bottom part), we notice that parameter p₃ depends on the value of p₁, i.e., πₚ_{₁}_{,p}_{₃}=1. Since p₁∈A_{α}_{₁}, decisions taken by α₁ indirectly affect the value of parameters controlled by α₂, which is an indirect conflict.

### Detecting Implicit Conflicts

Implicit conflicts are defined in Definition 3. Although these conflicts are harder to model because they depend on intrinsic relationships between control parameters and observable KPMs, they can be detected using a procedure that is similar to that used for indirect conflicts. Specifically, the graph G^{K} can be augmented by adding nodes such that each node a represents an application in A*. Moreover, edges (α, p)∈A*×P are added such that α_{α,p}=1.

An example of this graph is shown in FIG. 6. As shown, implicit conflicts can be identified by identifying which KPM nodes have more than one impacting edge. In this example, α₂ controls {p₂, p₃} while α₁ controls {p₁, p₂}. Indeed, while the two applications generate a direct conflict on p₂, k₁ depends on both p₁ and p₃. Since the two applications control both control parameters, k₁ is affected by an implicit conflict.

Implicit conflicts can be identified via the following two sets:

$${Π}^{IM} ( {A}^{*} ) = \{ k ∈ K : {\sum }_{p ∈ {⋃}_{a ∈ {A}^{*}} {P}_{a}} {ϵ}_{p , k} > 1 \} \qquad Eq . ( 5 )$$

$$and$$

$${Θ}_{p}^{IM} ( {A}^{*} ) = \{ a ∈ {A}^{*} : {α}_{a , p} = 1 \} \qquad Eq . ( 6 )$$

for each parameter p∈Π^{IM}(A*).

### Evaluating Conflicts

Detecting conflicts is important because it offers information regarding which applications will conflict with each other and, more importantly, which parameters and KPMs will be affected. However, another important aspect of conflict management in O-RAN is that of understanding the severity of conflicts prior to the deployment of the set of rApps, xApps and dApps. This is particularly important because some conflicts might happen frequently, but their impact on network performance and efficiency might be tolerable under certain conditions, whereas other conflicts may happen infrequently but be entirely unacceptable.

The Conflict Evaluation Module of PACIFISTA has been designed to accomplish this latter task. As shown in FIG. 3, this module analyzes each conflict detected in the prior phase over the application set A*, and outputs a conflict report that contains a set of indexes that measure the gravity of the conflict and their potential impact on network performance.

In the following, a set of metrics is introduced that is used in PACIFISTA to characterize conflicts, and provide methods to compute them via PACIFISTA's Conflict Evaluation Module 825.

Table 1 summarizes several metrics that have been used in PACIFISTA to provide an assessment of the severity of conflicts between O-RAN applications. To simplify the notation, in Table 1 the general definition of such metrics for two one-dimensional generic ECDFs F(x) and G(x) are provided with x∈R being a random variable.

TABLE 1
Distance functions used in PACIFISTA to evaluate conflicts in O-RAN. N is
the combined number of samples x in F₁(x), F₂(x); L is the length max(x) − min(x) As
explained above, a focus was placed on ECDFs, which provide an accurate representation on
the decision making of each application for a certain operational condition c ∈ C.

| ID | Name | Equation | Description | Range |
|---|---|---|---|---|
| K-S | Kolmogorov-Smirnov | max\|F₁−F₂\| | Maximum vertical distance between the two ECDEs. | [0, 1] |
| Ar | Integral (area) | $\frac{\text{?}}{L} \int \vert {F}_{1} - {F}_{2} \vert$ | Integral of the absolute value of the distance between the two ECDFs. | [0, 1] |
| C-VM | Cramer-Von Mises | Σ\|F₁ − F₂\| | Similar to K-S distance, but considers the distance over all the x | [0, N] |
| | | | axis. | |
| A-D | Anderson-Darling | $\sum \frac{\vert {F}_{1} - {F}_{2} \vert}{{F}_{1} ( \text{?} - {F}_{2} )}$ | Similar to the C-VM distance, but gives more weight to the tails. | [0, N) |
| EMD | Wasserstain (or Earth’s Mover) | ∫\|F₁ − F₂\| | Similar to the C-VM distance but considers areas instead of | [0, N) |
| | | | lines. It measures the minimum amount of work required to | |
| | | | transform one distribution into the other. | |
| DTS | DTS | ${\int }_{L} \frac{\vert {F}_{1} - {F}_{2} \vert}{{F}_{2} ( \text{?} - \text{?} )}$ | Similar to the A-D distance but considers areas instead of lines. | [0, N) |
| K-L | Kullback-Leibler | ${KL}_{i , j} = \sum {F}_{i} ln \frac{\text{?}}{\text{?}}$ | Measures the similarity between two probability distributions. | Range? |
| J-S | Jensen-Shannon | $\frac{1}{2} {KL}_{1 , M} + \frac{1}{2} {KL}_{2 , M}$ | Measures the similarity between two probability distributions, $derived from the K ‐ L with M ≃ \frac{1}{2} ( {F}_{1} + {F}_{2} ) .$ | Range? |
| TV | Total Variation | $\frac{1}{2} \sum \vert {F}_{1} - {F}_{2} \vert$ | Measures the total discrepancy between two distributions. | Range? |

$\text{?} \text{indicates text missing or illegible when filed}$

The evaluation process in PACIFISTA is executed in steps and, in some embodiments, includes selecting two applications α′ and α″ and retrieving their statistical profile. The process also includes selecting an operational condition c E C of interest.

For each p∈P_{α′}×P_{α″}, ECDFs of the two applications are extracted with respect to p, say F_{α′}(p|c) and F_{α″}(p|c). Table 1 can be used to compute the distance between F_{α′}(p|c) and F_{α″}(p|c) for each p∈P_{α′}×P_{α″}. This distance is referred to as D_{α′,α″}^{f}(p|c), where f represents the specific metric used to compute the distance as identified in Table 1. For example, D_{α′,α″}^{K-S}(p|c) represents the Kolgomorov-Smirnov (KS) distance between applications α′ and α″ with respect to control parameter p under operational conditions c.

Similarly, for each k∈K, the ECDFs of α′ and α″ are extracted with respect to KPM k. With a slight abuse of notation, these ECDFs are denoted as F_{α′}(k|c) and F_{α″}(k|c), respectively. the distance between F_{α′}(k|c) and F_{α″}(k|c) for each k∈K via Table 1. D_{α′,α″}^{f}(k|c) is used to indicate the distance between α′ and α″ with respect to KPM k, under conditions c and for a certain metric with identifier f (from Table 1). The computed distances metrics with respect to f are combined to generate two arrays defined as D_{α′,α″}^{f}(P, c)=(D_{α′,α″}^{f}(p|c))_{p∈P} and D_{α′,α″}^{f}(K, c)=(D_{α′,α″}^{f}(k|c))_{k∈K}. D_{α′,α″}^{f}(P,c) describes how two applications α′ and α″ differ in terms of decision making policies (e.g., how differently they control the same set of parameters), while D_{α′,α″}^{f}(K, c) describes how the two applications impact KPMs as a consequence of their different decision making.

Both D_{α′,α″}^{f}(P,c) and D_{α′,α″}^{f}(K,c) are processed to generate a detailed report describing conflicts between the two applications α′ and α″. The report contains information regarding the existence of direct, indirect and implicit conflicts, statistical information detailing how conflicts impact KPMs and parameters, as well as a set of indexes that are used by PACIFISTA to express the severity of each conflict.

### The Conflict Report

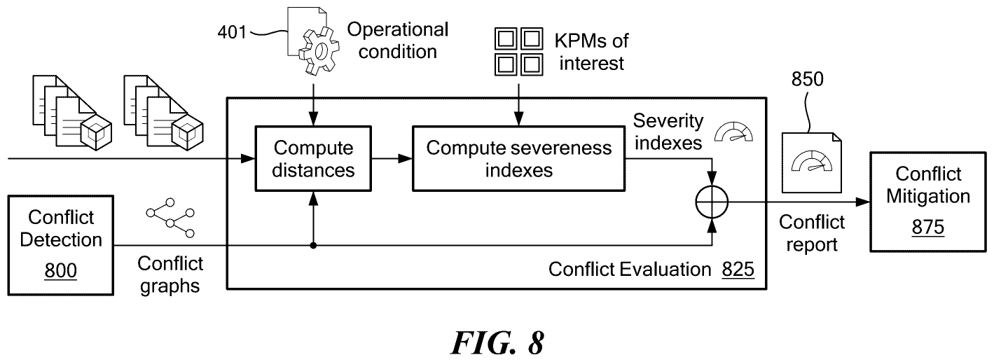

PACIFISTA leverages the information produced so far to generate the conflict report 850. The objective of this report is two-fold: (i) identify the existence of any type of conflict; and (ii) provide augmented information on how severe these conflicts are with respect to operators' objectives. Its generation is illustrated in FIG. 8.

For a given set A* of applications to be evaluated, the conflict report 850 contains the following elements:

Conflict existence: the first elements included in the report are the sets Π^{DC}(A*), Π^{IDC}(A*), Π^{IM}(A*), Θₚ^{DC}(A*), Θₚ^{IDC}(A*), Θₚ^{IM}(A*) for each parameter p∈P as defined in Eqs. (1)-(6). These sets identify all types of conflicts, which parameters are subject to such conflicts and which applications cause them. PACIFISTA also includes the augmented graphs built in Section 5 which are used to visualize conflicts. An example of the augmented graph used to visualize direct and implicit conflicts is shown in FIG. 5.

Conflict Severity: the other important information included in the conflict report 850 is related to the severity of each conflict. Specifically, conflicts are evaluated by comparing two O-RAN applications at a time. For a given set A* of applications of interest with cardinality A*, there is a total of A*(A*−1)/2 conflict pairs. Note that conflict evaluation between two apps (α′, α″) is the same as evaluating (α″, α′).

For each pair PACIFISTA computes three severity indexes σ_{α′,α″}^{DC}(P*|c), σ_{α′,α″}^{IDC}(P*|c), σ_{α′,α″}^{IM}(K*|c). Each index summarizes how severe are the different conflicts by combining the distances D_{α′,α″}^{f}(p|c) previously computed for each parameter p under operational condition c. To combine the different distances and compute the severity indexes under condition c, a combining function H(·) following the criteria in Table 2, which make it possible to extract a single value for each conflict, for example, using maximum, median, average operators.

TABLE 2
Combining functions used in H(•) to
compute the conflict severeness indexes.

| H(•) | |
|---|---|
| Function | Description |
| Average | Represents the average value. Outliers have a large impact. |
| Median | Represents the middle value in a set of values when |
| | arranged in ascending order. Outliers have limited impact. |
| Maximum | Represents the maximum value in a set of values. |
| value | |

It is worth mentioning that PACIFISTA computes the severity indexes based on the specific operational condition c. This is important as applications might generate conflicts only under certain conditions, and the severity of such conflicts might vary by a great deal under diverse operational conditions. For this reason, in PACIFISTA operators need to specify the operational conditions of interest prior to generating a report.

### Mitigating Conflicts

Once the conflict reports has been generated, operators can use the information contained therein to determine which applications to deploy in order to avoid conflicts that might result in heavy fluctuations and performance degradation. In practical applications, conflicts are likely to occur with nonzero probability due to coupling between control parameters and KPMs, limited amount of resources that result in competition between users, as well as conflicting intents (e.g., energy minimization against demand for high performance). This means that operators need either to deploy only a handful of applications that can act in concert and serve a few type of subscribers and deliver a certain class of services); or to tolerate a certain degree of conflict.

Although the first approach indeed minimizes the occurrence of conflicts, it also makes it difficult to satisfy performance requirements for a variety of services and applications. For this reason, the second approach is considered, assuming that the operator specifics a certain conflict tolerance level δTOL. The parameter δTOL specifies the maximum level of conflict that the operator is willing to tolerate when deploying O-RAN applications that are in conflict which each other. It is also assumed that the operator can submit a priority index I_{α} for each application α∈A which reflects the importance that the operator gives to each applications.

Upon receiving the set A* of applications to be evaluated, the conflict mitigation module uses the indexes computed by PACIFISTA via the procedures described above to determine which ORAN applications to deploy so as to mitigate conflict occurrence.

PACIFISTA implements a threshold-based conflict mitigation strategy where the tolerance level δTOL is used to identify the applications that would generate too high of a conflict and should not be deployed at that time. The procedure to identify which applications to deploy using a threshold-based method includes a step wherein PACIFISTA first identifies all of the applications in A* that can be deployed without generating any type of conflict. These applications are added to a set A^{DPLY} of applications to deploy, which is initially set to A^{DPLY}=Ø. Then, second, α=arg max_{α∈A*/A}_{^{DPLY}}{I_{α}} is selected. If the severity index for α is below δTOL, it is added to A^{DPLY}, otherwise it is discarded. Step 3: The second step is then repeated until no more applications can be added to A^{DPLY}.

### Advantages and Improvements of the Present Technology Include:

Prior art technologies only consider deconfliction in real-time (i.e., determining which action to take when receiving two conflicting actions) whereas the systems and methods described herein provide information a-priori to avoid the occurrence of conflicts in the first place.

The systems and methods provided herein capture and describe the dynamics of conflicts under certain operational conditions because, while conflicts do not always arise, they may be strong in certain operational conditions and weak in others. In particular, the systems and methods provided herein generate conflict reports that are specific to every operational condition to aid in identifying which AI solutions will generate conflicts under the operational conditions of interest, rather than identifying all possible risk in the abstract. Thus, the methods and systems provided herein effectively de-risk AI applications in O-RAN.

Overall, the present technology offers a data-driven approach that reduces the risk of deploying applications that will produce performance degradations, unfairness and inefficiencies.

Industrial applications of the present technology include open RAN networks, including O-RAN networks, any wireless network where independent applications can compete with each other to control the network (e.g., where independent applications might generate conflicts), legacy 4G/5G networks where intelligence runs in SMO, EMS and other cloud hosts, and AI-based wireless networks with distributed control via multiple control applications.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

[1] Cezary Adamczyk. 2023. Challenges for Conflict Mitigation in O-RAN's RAN Intelligent Controllers. In 2023 International Conference on Software, Telecommunications and Computer Networks (SoftCOM). IEEE, 1-6.
[2] Cezary Adamczyk and Adrian Kliks. 2023. Conflict Mitigation Framework and Conflict Detection in O-RAN Near-RT RIC. IEEE Communications Magazine (2023).
[3] Leonardo Bonati, Salvatore D'Oro, Stefano Basagni, and Tommaso Melodia. 2021. SCOPE: An open and softwarized prototyping platform for NextG systems. In Proceedings of the 19th Annual International Conference on Mobile Systems, Applications, and Services. 415-426.
[4] Leonardo Bonati, Pedram Johari, Michele Polese, Salvatore D'Oro, Subhramoy Mohanti, Miead Tehrani-Moayyed, Davide Villa, Shweta Shrivastava, Chinenye Tassie, Kurt Yoder, et al. 2021. Colosseum: Large-scale wireless experimentation through hardware-in-the-loop network emulation. In 2021 IEEE International Symposium on Dynamic Spectrum Access Networks (DySPAN). IEEE, 105-113.
[5] Leonardo Bonati, Michele Polese, Salvatore D'Oro, Stefano Basagni, and Tommaso Melodia. 2023. OpenRAN Gym: AI/ML development, data collection, and testing for O-RAN on PAWR platforms. Computer Networks 220 (2023), 109502.
[6] Salvatore D'Oro, Michele Polese, Leonardo Bonati, Hai Cheng, and Tommaso Melodia. 2022. dapps: Distributed applications for real-time inference and control in o-ran. IEEE Communications Magazine 60, 11 (2022), 52-58.
[7] Salvatore D'Oro, Leonardo Bonati, Michele Polese, and Tommaso Melodia. 2022. Orchestran: Network automation through orchestrated intelligence in the open ran. In IEEE INFOCOM 2022-IEEE Conference on Computer Communications. IEEE, 270-279.
[8] Pedro Enrique Iturria-Rivera, Han Zhang, Hao Zhou, Shahram Mollahasani, and Melike Erol-Kantarci. 2022. Multi-agent team learning in virtualized open radio access networks (o-ran). Sensors 22, 14 (2022), 5375.
[9] Andrea Lacava, Matteo Bordin, Michele Polese, Rajarajan Sivaraj, Tommaso Zugno, Francesca Cuomo, and Tommaso Melodia. 2023. ns-O-RAN: Simulating O-RAN 5G Systems in ns-3. In Proceedings of the 2023 Workshop on Ns-3 (Arlington, VA, USA)(WNS3 '23). Association for Computing Machinery, New York, NY, USA, 35â€″44. doi.org/10.1145/3592149.3592161
[10] Unwired Labs. [n. d.]. OpenCelliD. opencellid.org. Accessed November 2023.
[11] Han Zhang, Hao Zhou, and Melike Erol-Kantarci. 2022. Team learning-based resource allocation for open radio access network (O-RAN). In ICC 2022-IEEE International Conference on Communications. IEEE, 4938-4943.

What is claimed is:

1. A method for detecting, evaluating, and mitigating conflicts in an open radio access network (open RAN) comprising:
providing a plurality of applications deployable on the open RAN, each of the plurality of applications configured to control a corresponding parameter set including at least one operational parameter of the open RAN;
generating, in a profiler component, an application profile for each of the plurality of applications by:
simulating a behavior of each application with respect to the corresponding parameter set under a predefined plurality of operational condition sets, and
compiling a statistical profile of each application for each of the predefined plurality of operational condition sets, the statistical profile characterizing configuration of the corresponding parameter set by the application under the corresponding operational condition set;
receiving, at a conflict detection component, a request to instantiate at least one of the applications on the open RAN,
obtaining current operational data from the open RAN;
determining, by the conflict detection component, a predicted existence of at least one conflict between the requested application and one or more currently instantiated applications;
determining, by a conflict evaluation component, a predicted frequency and a predicted severity of at least one conflict between the requested application and one or more currently instantiated applications, wherein the predicted severity represents a magnitude of predicted deviation from key performance measurements of the open RAN resulting from the at least one conflict;
generating, based on the determined predicted frequency and severity of the at least one conflict, a conflict report;
developing, by application of a conflict mitigation policy of the open RAN to the conflict report in a conflict mitigation component, a conflict mitigation scheme and, according to the conflict mitigation scheme, at least one of:
blocking instantiation of the requested application;
instantiating the requested application; or
uninstantiating at least one of the currently instantiated applications.

2. The method of claim 1, wherein one or more of the profiler component, the conflict detection component, the conflict evaluation component, the conflict mitigation component, or combinations thereof is executed at a Service Management and Orchestration of the open RAN.

3. The method of claim 1, wherein the plurality of applications deployable on the open RAN include one or more rApps, xApps, dApps, or combinations thereof.

4. The method of claim 1, wherein the at least one conflict includes one or more of:
a direct conflict, wherein the requested application is configured to control a same parameter as at least one of the currently instantiated applications;
an indirect conflict, wherein the requested application is configured to control at least one parameter that directly affects a value of a parameter controlled by at least one of the currently instantiated applications;
an implicit conflict, wherein the requested application is configured to control at least one parameter that affects a same key performance measurement as a parameter controlled by at least one of the currently instantiated applications; or
combinations thereof.

5. The method of claim 1, wherein conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.

6. The method of claim 1, wherein the conflict mitigation policy includes a conflict tolerance defining:
a tolerable deviation with respect to one or more of the key performance measurements;
a tolerable deviation with respect to one or more operational parameters of the open RAN; or
a combination thereof.

7. The method of claim 1, further comprising receiving, from an operator, based on the conflict report, a change to the requested application, a request for deployment of a different application, a request for a change to the conflict mitigation policy, or combinations thereof.

8. The method of claim 1, wherein the operational condition sets each include at least one of a number of user equipments, a cell load, a signal-to-noise-ratio, channel quality information conditions, or combinations thereof.

9. The method of claim 1, wherein the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof.

10. The method of claim 1, wherein the statistical profile includes at least one of a Probability Distribution Function, a Cumulative Distribution Function, an Empirical Cumulative Distribution Function, or combinations thereof.

11. A system for detecting, evaluating, and mitigating conflicts in an open radio access network (RAN) comprising:
a profiler component configured to:
receive a plurality of applications deployable on the open RAN, each configured to control a corresponding parameter set including at least one operational parameter of the open RAN, and
generate an application profile for each of the plurality of applications by simulating a behavior of each application with respect to the corresponding parameter set under a predefined plurality of operational condition sets, compiling a statistical profile of each application for each of the predefined plurality of operational condition sets, the statistical profile characterizing configuration of the corresponding parameter set by the application under the corresponding operational condition set;
a conflict detection component configured to:
receive a request to instantiate one of the applications on the open RAN,
obtain current operational data from the open RAN, and
determine a predicted existence of at least one conflict between the requested application and one or more currently instantiated applications;
a conflict evaluation component configured to:
determine a predicted frequency and a predicted severity of the at least one conflict between the requested application and one or more currently instantiated applications, wherein the predicted severity represents a magnitude of predicted deviation from key performance measurements of the open RAN resulting from the at least one conflict, and
generate, based on the determined predicted frequency and severity of the at least one conflict, a conflict report;
a conflict mitigation component configured to develop, by application of a conflict mitigation policy of the open RAN to the conflict report, a conflict mitigation scheme and, according to the conflict mitigation scheme, at least one of:
block instantiation of the requested application;
instantiate the requested application; or
uninstantiate at least one of the currently instantiated applications.

12. The system of claim 11, wherein one or more of the profiler component, the conflict detection component, the conflict evaluation component, the conflict mitigation component, or combinations thereof is executed at a Service Management and Orchestration of the open RAN.

13. The system of claim 11, wherein the plurality of applications deployable on the open RAN include one or more rApps, xApps, dApps, or combinations thereof.

14. The system of claim 11, wherein the at least one conflict includes one or more of:
a direct conflict, wherein the requested application is configured to control a same parameter as at least one of the currently instantiated applications;
an indirect conflict, wherein the requested application is configured to control at least one parameter that directly affects a value of a parameter controlled by at least one of the currently instantiated applications;
an implicit conflict, wherein the requested application is configured to control at least one parameter that affects a same key performance measurement as a parameter controlled by at least one of the currently instantiated applications; or
combinations thereof.

15. The system of claim 11, wherein conflict severity is determined according to one or more of a Kolmogorov-Smirnov function, an Integral of an absolute value of a distance between two Empirical Cumulative Distribution Functions, a Cramer-Von Mises function, an Anderson-Darling function, a Wasserstain function, a Distance Transform of Sampled function, a Kullback-Leibler function, a Jensen-Shannon function, a Total Variation function, or combinations thereof.

16. The system of claim 11, wherein the conflict mitigation policy includes a conflict tolerance defining:
a tolerable deviation with respect to one or more of the key performance measurements;
a tolerable deviation with respect to one or more operational parameters of the open RAN; or
a combination thereof.

17. The system of claim 11, the conflict mitigation component further configured to receive, from an operator, based on the conflict report, instructions requesting a change to the requested application, requesting deployment of a different application, requesting a change to the conflict mitigation policy, or combinations thereof.

18. The system of claim 11, wherein the operational condition sets each include at least one of a number of user equipments, a cell load, a signal-to-noise-ratio, channel quality information conditions, or combinations thereof.

19. The system of claim 11, wherein the at least one operational parameter of the open RAN of the corresponding parameter set includes at least one of a transmission power of one or more base stations of the open RAN, a transmission bandwidth, radio resource block allocation, a control scheme, a transmission range, a network throughput, a network energy consumption, or combinations thereof.

20. The system of claim 11, the statistical profile includes at least one of a Probability Distribution Function, a Cumulative Distribution Function, an Empirical Cumulative Distribution Function, or combinations thereof.
